(19) United States
(12) Patent Application Publication
(10) Pub. No.: US 2007/0014458 A1
(43) Pub. Date: Jan. 18, 2007

(54) Method for achieving "virtual resolution enhancement" of a diagnostic imaging modality by using coupled FEA analyses

(76) Inventors: Mark Lawson Palmer, Grandville, MI (US); Mark Benjamin Willis, Canton, MI (US)

Correspondence Address: Stephen J. Brown, Esq.;BRYAN CAVE LLP, 33rd Floor, 1290 Avenue of the Americas, New York, NY, 10104, US

(21) Appl. No.: 11/432,818

(22) Filed: May 11, 2006

Related U.S. Application Data
(60) Provisional application No. 60/680,076, filed on May 12, 2005.

(51) Int. Cl. G06K 9/00

(52) U.S. Cl. 382/128

(57) ABSTRACT

A method and computer-implemented system for enhancing the capability of an imaging modality by coupling it with physiological models constructed at length scales below the resolution of the imaging modality. The present invention involves the use of multiple, coupled FEA analyses operating at different length scales to increase the utility of image data from a diagnostic imaging modality by achieving “virtual resolution enhancement.” The preferred embodiment uses asymptotic homogenization FEA methods to map physiological data to the high-level model based on the diagnostic imaging modality and/or to micro-level model(s) based on theoretical or alternative imaging modalities.

The present invention generally relates to the use of Finite Element Analysis (FEA) methods for enhancing the utility of a diagnostic imaging modality. More particularly, the present invention relates to a method for mapping images from the diagnostic imaging modality to an FEA model and for coupling FEA analysis of this model with additional FEA analysis instances operating on micro-level models in order to achieve “virtual resolution enhancement.” Specifically, the coupling of the FEA analyses enables mapping of the physiological data derived from the imaging modality and analyses to either the global or micro-level.

The various types of imaging modalities can be categorized:

1) Non-invasive like ultrasound, MRI, CAT & nuclear scans

2) Invasive like microscopy, electron micrographs & histology

For many medical problems only non-invasive imaging techniques are appropriate. For example, in an emergency room cardiac scenario or with other diagnostic imaging tests on people, there are serious limitations preventing a doctor from being able to simply rip out the relevant tissue to image it with invasive techniques, for example using a biopsy to take some of the heart.

Where they are applicable, the invasive imaging techniques generally have very good levels of resolution. Electron microscopy, for example, can image down to the micron length scale. Conversely, the smallest resolution of non-invasive imaging is orders of magnitude larger. CT, for example, has only just recently been able to image smaller than the 1 mm length scale.

There is an additional problem that restricts the potential of pushing the limits of non-invasive imaging techniques significantly lower than their current capabilities. Namely, the underlying physics used in the non-invasive imaging has limitations on how small it can be pushed. CT, for example, is 80% of the way to its theoretical physical limit. Thus, while enhancements in these imaging techniques will continue to provide more data and faster access to images, they will not be able to provide images at significantly smaller levels of resolution.

This presents a problem for the physician who is interested in clinically relevant events that occur below the level of the imaging resolution of non-invasive imaging techniques like CT. For example, in an acute cardiac situation, understanding the activity at the level of the myocytes (muscle cells in cardiac muscle) in the patient's heart would be tremendously valuable in assessing the urgency of the situation and the required intervention. However, this length scale is inaccessible to the non-invasive modalities since imaging at the level of microns is needed to view the myocytes.

Thus, if there were some way to “look deeper” than the physical limits of the non-invasive imaging modality, the physician would be able to leverage additional information that could prove critical in a correct assessment of the patient's condition. Doing so would require the ability to somehow glean information from a diagnostic imaging modality based on physiological events occurring below the level of resolution of the imaging modality. On the face of it, this seems like an impossible capability to realize.

However, the present invention provides exactly this capability, and does so by leveraging the functionality of computational modeling. In particular, the preferred embodiment uses Finite Element Analysis (FEA). FEA is a computational modeling technique used to break the continuous world up into discrete chunks, so that math can be used to model the behavior of an entity. Several aspects of computational modeling using FEA are critical for the present invention:

1. FEA models based on physiological data can be created at any length scale. This data can come from a theoretical understanding of the physical system, or any imaging modality, such as but not limited to microscopy, electron micrographs, histology, various physical experiments, etc.

2. Patient-specific image data can be mapped to population profile based models that are constructed a priori. This provides a way of transforming a general model of a physical system into one that is specific to the patient of interest.

3. Multiple FEA models can be coupled with each other to provide concurrent, interdependent modeling of different aspects of a physical system. More specifically, using models that are focused on different length scales, a concurrent analysis can be done on an entity in which the analysis on each level informs the analysis at other levels. For example, models operating at the length scale of the patient's heart and at the level of the myocytes can be coupled to enable enhanced modeling of the patient heart. For this purpose it may be preferable to use coupled multi-level finite element analyses. A method and system for such coupled multi-level finite element analyses is disclosed in a U.S. provisional patent application filed concurrently herewith and identified by attorney docket number PAT008 PP300 and titled “METHOD FOR USING COUPLED FEA ANALYSES OF DIFFERENT LEVELS OF ORGANIZATION WITHIN AN ENTITY TO ANALYZE THE ENTITY,” the entire disclosure of which is incorporated herein by reference and is physically incorporated herein as Attachment A.

4. The physiological data and modeling results can be mapped to models used in any of the FEA analysis. For example, the results of a heart-related multi-level model can be mapped to the level of the heart and/or the level of the myocyte. Thus, the physiological parameters can be computed and mapped up or down to various length scale models that are developed a priori and then applied or customized to the specific patient.

5. Graphical user interface functionality can be used to visually present the data in a synchronized way. This enables a physician to view the modeling results and “see” a virtual movie of what that modeling predicts is occurring at each of the length scales.

The present invention leverages these aspects of computational modeling to provide a way of “looking deeper” than the resolution of the imaging modality. Practically, the impact to medical diagnosis and patient treatment planning is great, since incorporating physiological activity that may exist below the level of resolution of the imaging modality enhances the utility of the images to provide a more complete picture into the physical state of the patient.

In accordance with the present invention, a method for using mapping images from a diagnostic imaging modality to an FEA model and for coupling this coupling FEA analysis of this model with additional FEA analysis instances operating on micro-level models in order to achieve “virtual resolution enhancement.” The method includes selecting the appropriate micro-level model for regions of interest in the high-level model. Following the definition of the FEA parameters, multiple, concurrent FEA analyses are performed and the results are mapped back to the FEA models, thus showing what may be happening in the patient not only at the level of the imaging modality, but at a length scale much smaller as well.

Further areas of applicability of the present invention will become apparent from the detailed description provided hereinafter. It should be understood that the detailed description and specific examples, while indicating a preferred embodiment of the invention, are intended for purposes of illustration only and are not intended to limit the scope of the invention.

One system which implements principles of the present invention is comprised of an imaging modality, which feeds image data to a “mapping” function which configures and customizes patient-specific versions of FEA models constructed a priori. The system further includes the use of multiple, concurrent FEA analyses, operating concurrently at the length scale of the imaging modality as well as at smaller length scales, the results of which are displayed using an FEA post processing graphical user interface.

The present invention will become more fully understood from the detailed description and the accompanying drawings, wherein:

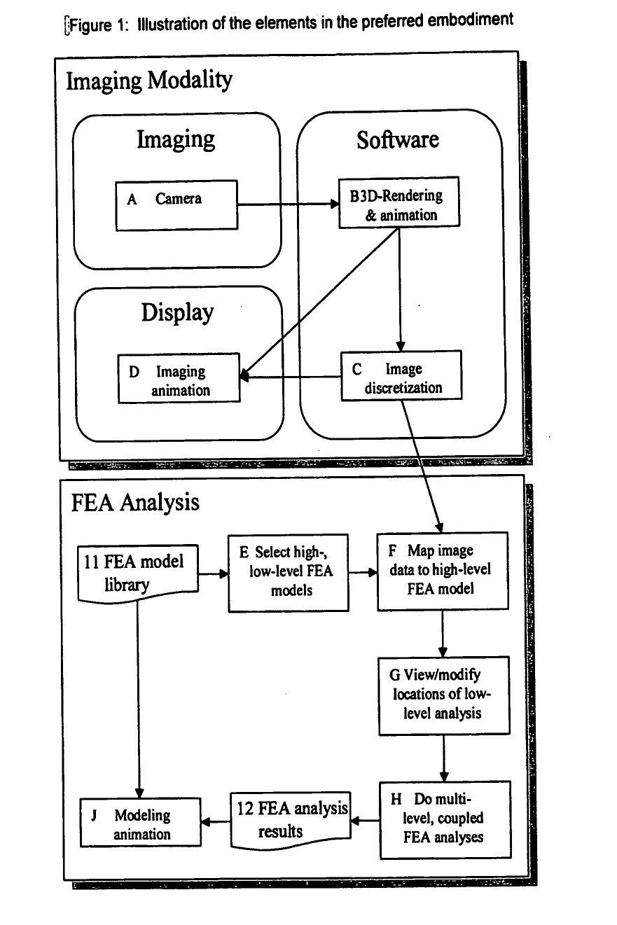

FIG. 1 illustrates an example of the preferred embodiment, including the imaging modality, computer modeling software and graphical interface used to display results.

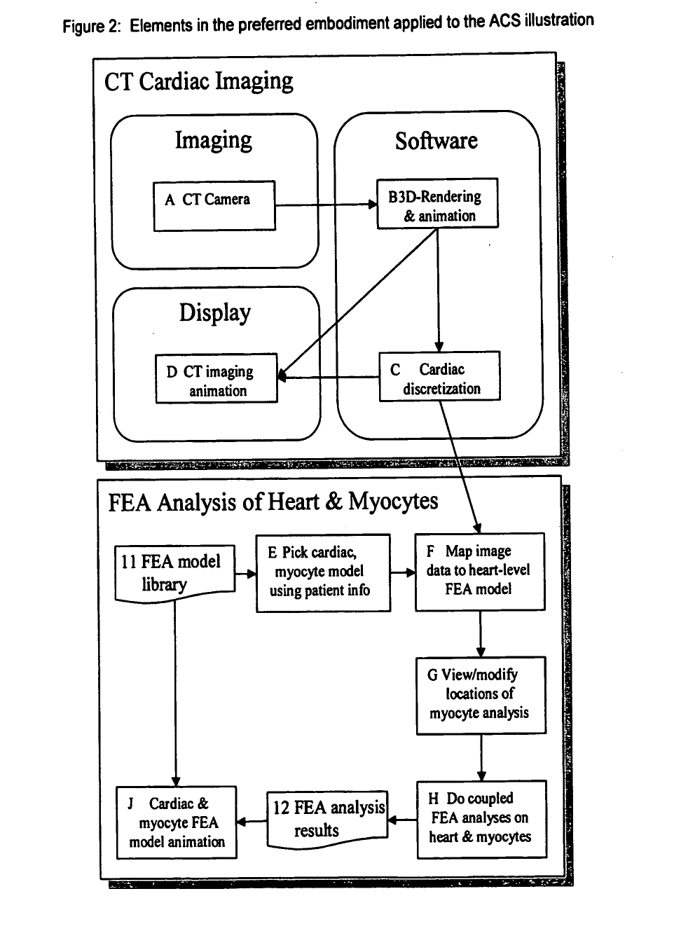

FIG. 2 illustrates the application to the ACS illustration using CT imaging by modifying FIG. 1 based on the ACS example.

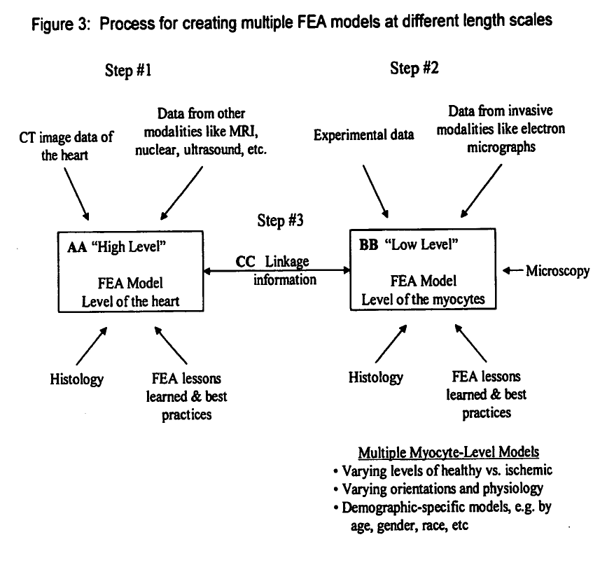

FIG. 3 illustrates the process of creating multiple FEA models at different length scales.

The following description of the preferred embodiment(s) is merely exemplary in nature and is in no way intended to limit the invention, its application, or uses.

For the sake of illustration, the example of an acute cardiac event is used to describe use of the current invention to facilitate diagnosis. In this scenario, a patient presents at an emergency clinic or hospital with symptoms consistent with acute cardiac syndrome (ACS). At the forefront of the physicians mind is the task of determining whether there really is an ACS issue or not. The physician frequently uses a diagnostic imaging modality to support this investigation, and for the purposes of illustration this description will assume the use of a Computer Aided Tomography diagnostic imaging modality, also known at CAT scan or CT.

The preferred embodiment of the present invention supports the goal of evaluating the patient's condition by enhancing the imaging data provided by an imaging modality like CT to increase its utility in supporting the physician's search for cause and treatment planning. This is accomplished in the present illustration by mapping the patient-specific image data to computational models of the heart so that computational modeling can be done based on the patient-specific physiological data gathered via the CT imaging.

FIG. 1 illustrates an embodiment of the present invention. Aspects of the imaging modality appear at the top, and aspects specific to the use of computational modeling using FEA analysis appear at the bottom. Within the imaging modality functionality, the camera (A) generates images which are manipulated using the bundled software tools (B, C) and a user view images and animations based on the imaging (D).

The FEA analysis elements to the present invention include a process of selecting the appropriate FEA models for the high and low level analyses (E). These models are selected from a library of models (11) based on various criteria related to the target of the imaging. The imaging discretization is mapped to the high-level FEA model (F), which also selects which regions of the high-level model should be analyzed with a low-level analysis. Following potential modification to these selections (G), the FEA analyses execute (H) and generate results (12) for both the high and low level models. These results can then be viewed and animated by mapping them to the FEA models used in the analyses (J).

For illustrative purposes, an embodiment of the present invention can be applied to the illustration of the patient presenting acute ACS, using diagnostic CT imaging. This is illustrated in FIG. 2, which has been modified to align with the present illustration. In this case, (A) is a CT camera, (B, C) the software platform associated with the CT scanner and (D) the display capability of the CT imaging system. The FEA analysis requires selection of the appropriate heart and myocyte models (E) based on the patient demographic and history. The discretization of the CT image data of the heart (C) is mapped to the heart FEA model (F). After the physician views/modifies the locations in the heart where the myocyte-level analysis should be done (G), the coupled FEA analyses are done. The generated results (12) are mapped back onto the heart and FEA models (11) so the physician can view animations of the predicted cardiac function, at a high-level, corresponding to the CT imaging animation (D), or at a lower-level, viewing the myocyte-level activity predicted by the FEA analyses.

It is clear that the FEA model library (11) must exist a priori before the preferred embodiment can be used for patient-specific diagnosis and treatment planning. The key to the present invention is being able to use this library to marry the imaging data from the diagnostic imaging modality with data based on physiologically-relevant models at length scales below the resolution of the imaging modality.

Thus, in this first embodiment of the present invention for use with the ACS illustration, computational models at 2 length scales (the level of the heart itself and the level of the cardiomyocytes) must be constructed, as illustrated in FIG. 3:

Step #1. Create computational model(s) at the length scale of the resolution of the imaging modality (A). The image data from the CT scan will be used to map to this model. Thus, this first model is a model of the complete heart, defined at roughly the millimeter length scale. This model must correspond to the length scale of the imaging modality because the images from the imaging device will be mapped to this computational model. Consequently, the discretization is often based on the images from the imaging modality itself, for example CT in the present illustration. In fact, imaging software such as the Brilliance CT software platform bundled with Philips CT imaging systems can automatically generate a 3D volumetric rendering of the scanned organ. This serves as the basis for developing an FEA model of the heart, which is created by first discretizing the continuous 3D volumetric model generated by the Brilliance CT software and then refining it in lieu of the constraints of FEA analysis best practices, as well as based on additional data from other imaging modalities and histology.

Step #2. Create computational model(s) at a length scale smaller than the resolution of the imaging modality (B). For the illustration of managing potential ACS, one of the clinically relevant questions is, “what is happening in the myocytes (muscle cells) at various places in the patient's heart and how are they impacting the overall cardiac function?” This question drives the composition of the computational model(s) constructed at a length scale below the resolution of the imaging modality. For example, a model focused on the physiology of a myocyte would encapsulate the activity of the cardiac muscle cells by modeling the protein-level behavior of each cell and the cellular-level interacting with adjoining cells. The 3 types of muscle cells, cardiac, smooth and skeletal, each have variations in composition and are used in different ways within the various types of muscles. These models are at the micron length scale, which is 3 orders of magnitude smaller than the current resolution of non-invasive imaging modalities like CT imaging. Notice that several myocyte-level models would be used in the present illustration, because the heart is not homogenous at the myocyte-level throughout its structure, but rather heterogeneous, both in structure and alignment of the myocytes. Additionally, various models are created which correspond to varying levels on the continuum between completely healthy and completely ischemic tissue.

Step #3. Create a physiologically relevant link between the 2 models (C). In the ACS example, the cardiomyocyte model(s) need to be linked to the heart models in a physiologically accurate way. For example, the orientation and makeup of the heart muscle varies from place to place in the heart. Linking the heart level model with multiple instances of analyses that are focused on the myocyte level requires describing these characteristics. Thus, for each element in the heart-level FEA model, an assignment is made to the appropriate myocyte-level FEA model(s) that most accurately describes the known physiology at that point in the heart. (Selection of which model to use in the healthy ←→ damaged continuum is based on patient-specific information during analysis on a specific patient.)

It is preferable that these computational models be physiologically relevant. These models are built using physical data, which can be generated from many sources, including, but not limited to, non-invasive imaging like ultrasound, MRI, CT and nuclear scanning, invasive procedures like microscopy, electron micrographs, histology and experimental data from physical experiments, as illustrated in FIG. 3. This data is used to generate the idealized physical data that is described using the computational models. Specifically, Finite Element Analysis (FEA) models are used in the preferred embodiment of the present invention. These models can also be population-specific, so as to be customized based on patent demographic data. Hence, the most appropriate member of the “family” of models of human hearts can be chosen based on the CT scan of the patient and the patient's demographic data. Similarly, the physician could also specify which myocyte-level model to use if the condition of parts of the heart were known a priori, for example based on prior cardiac problems.

Building the present invention requires generation of these models and specifying their linkage for the organ of interest, the heart in the present illustration. Then, during patient-specific analysis, these multiple FEA models are used to simulate the patient's cardiac function. This process involves the following steps, as illustrated by FIG. 2:
Step E) Select the correct heart and myocyte models based on patient information.
Step F) Map the image data from the CT scan to the heart-level FEA Model.
Step G) Prior to the analysis, the physician can specify which elements in the heart model should be coupled with myocyte-level analysis instances, or can let the system determine where to perform myocyte-level analysis based on the data from the imaging modality concerning the patient's heart function.
Step H) Run the coupled, concurrent FEA analyses, wherein the models at multiple length scales run concurrently, informing each other of behavior and activity at the higher/lower length scales.
Step J) Map the FEA analysis results (12) back onto the models (11), graphically showing the physician what the model predicts is happening at the heart level and the myocyte level in areas of interest.

The bridge from the diagnostic imaging device to the FEA computational models is obviously located in (F). The goal of this step is to use data from the imaging modality to map the behavior of the various parts of the heart to the elements in the FEA model of the heart. These data essentially provide boundary conditions which constrain the movement of the heart in the FEA model. Generally, the software accompanying the imaging modality supports generating 3D volumetric rendering of the imaged tissue (B, C). For example, Philips CT imaging systems include the Brilliance CT software platform that automatically generates a 3D volumetric rendering of the heart as a part of its software support for the physical CT imaging. This function facilitates mapping the image data to the FEA model, and provides a description of parameters which form inputs to the FEA analysis of the heart-level model. These generate patient-specific inputs to the heart-level FEA model that include chamber wall motion, length, stretch, strain, velocity, etc. The automated mapping of the CT image data to the heart-level FEA model assigns these constraints to the appropriate elements in the heart model. Additionally, it automatically connects elements in the heart model that have significant movement and activity to myocyte-level FEA instances so that they are modeled using a concurrent myocyte-level analysis. However, the physician may also want to include the myocyte-level analysis at other places in the heart or otherwise modify where the more detailed analysis is performed for reasons including, but not limited to, patient history. Thus, in the preferred embodiment of the present invention, human interaction could check the results of the automated mapping to verify/modify the assignments that were made automatically. (G)

Following the conversion of the imaging data to constraints used in the computational model of the heart (F, G), an FEA analysis can be run on the heart model to analyze measures like stress (H). (This is a primary predictor of what is physically happening in the patient's heart, and a key motivation for using the present invention in the present illustration.) However, the key to the present invention relates to extending the FEA analysis beyond just the level of the heart through the use of multi-level modeling—using multiple models at different length scales in concurrent, interrelated analyses. In the present illustration, the value of modeling the heart using a single level model at the length scale of the heart itself is more valuable than simply having the CT imaging data. However, dramatically increased the advantages gained by combining it with the myocyte-level information and physiology by mapping an element of the heart to the myocyte-level structural makeup of that part of the heart. The reason for this goes back to the primary goal of the physician in the present illustration, which is to determine what is going on with the patient's heart and how serious it is. The answers to that question depend heavily on what is actually happening at the level of the myocyte. For example, variations in wall movement of the chambers of the heart that are too minor to be noticed by the physician in a CT animation could actually indicate dramatically different myocyte-level activity in various regions of the heart. In particular, it could indicate stress levels in the myocytes that are critically high or force generation levels that are critically low, thus impacting diagnosis and treatment planning.

For these reasons, a desirable aspect of the present invention is the use of multi-level FEA modeling in (H). The preferred embodiment uses asymptotic homogenization FEA methods in an analysis using multiple FEA models. Specifically, in the present illustration, the preferred embodiment connects the model at the level of the heart with the instances of models at the level of the myocyte using homogenization methods to enable the various analyses to communicate with each other. In this manner, each analysis can inform the analyses at the other level of the model's state and behavior.

For example, consider an element in the heart-level FEA model that is connected to a separate, myocyte-level FEA model. At each step in the analysis, communication back and forth between the heart-level element and the myocyte-level model enables each to impact the other. The heart-level element communicates the high-level description of the movement of its location in the heart, which provides constraints on the myocyte-level model. Similarly, the myocyte-level model generates homogenized values that describe the properties of the entire myocyte-level model which are used at the heart-level to describe the corresponding element and thus inform the FEA analysis at the level of the heart. In the process, the myocyte-level model generates values such as force, stress, strain, length, displacement, velocity and a host of other properties that provide insight into what is happening in the individual myocytes that make up the specified location of the heart. These data not only impact the FEA analysis of the heart, but also can show the physician what is happening at the myocytes in that region of the heart.

Naturally, as with many computational modeling approaches, enormous amounts of data (12) are normally generated by the computationally-intensive FEA analysis (H). For this reason, the process of viewing the results via a graphical user interface (J) is critical to providing useful support to the physician in the present illustration of possible ACS in a patient. In (J) the results of the modeling are displayed in a graphical way by visually mapping the data from the heart- and myocyte-level FEA analyses back onto the models. This is done using a standard FEA post processing graphic tool which takes the analysis results and superimposes them on the FEA model. Animating the models provides visual cues that the physician can use in concert with the 3D volumetric rendering done by the CT itself (D).

Both models are relevant to the diagnostic utility of the present invention in the present illustration. Animating the heart-level model extends the diagnostic capability of the CT itself by providing additional information at the level of the heart itself. While the CT animation illustrates the movement of the heart and can show things like chamber wall motion, the FEA analysis overlays critically important data such as force or stress. In this process, the physiological data generated from the FEA model is simply mapped back to the FEA model of the heart, and animated based on the value of the appropriate data measure. For example, areas of high stress can be viewed in red and low stress in blue.

Even at the level of the heart, this side-by-side comparison of the animated CT image data (D) and the FEA model data (J) is useful in gaining a more accurate and detailed understanding of the patients cardiac function, especially because the heart-level analysis leveraged the concurrent myocyte-level analyses (H). However, an even greater benefit comes from mapping the physiological data generated by the FEA analyses at the myocyte-level onto the myocyte-level FEA models. These animations can provide much more detailed information about what is physically happening at the cellular level in the heart. This is immensely valuable to the physician because it enables the physician to see what stresses and forces exist at the level of the individual myocytes in a region of interest in the heart. It is this measure and prediction of how individual cells are functioning or failing that provides critical insight into treatment planning.

The description of the invention is merely exemplary in nature and, thus, variations that do not depart from the gist of the invention are intended to be within the scope of the invention. Such variations are not to be regarded as a departure from the spirit and scope of the invention. For example, the current invention applies to imaging modalities besides CT, the modality used in the ACS illustration. These include, but are not limited to, ultrasound, MRI, nuclear and PET imaging modalities. Similarly, while the focus of the illustration, the present invention applies equally well to imaging other tissue besides the heart. Still further, the present invention is not limited to diagnostic imaging within the medical field or even to diagnostic imaging regardless of the field in which it is used.

What is claimed is:

1. A method and computer-implemented system for integrating multiple FEA analyses with a diagnostic imaging modality to achieve “virtual resolution enhancement” in which the diagnostic information generated by the system enables looking deeper than the length scale of the resolution of the imaging modality, the system comprising:
(a) a diagnostic imaging modality capable of at least;
(i) imaging of an entity such as a patient or thing;
(ii) generating images that are passed to the image discretization function;
(b) an image discretization function capable of at least;
(i) analyzing the images generated by the imaging modality to discretize the images and map them to an FEA model developed a priori which is customized to the scanned entity-specific image data;
(c) one or more FEA models at the length scale of the resolution of the diagnostic imaging modality;
(d) one or more FEA models at a lower length scale(s) than the resolution of the imaging modality such that;
(i) The additional models are linked to the higher level model and enable multi-level FEA analysis;
(e) a multi-level FEA analysis that couples the 2 or more FEA analyses operating at 2 or more length scales.
(f) a graphical user interface system which enables viewing the results of the FEA analyses, at the length scale of the imaging modality as well as the smaller length scale(s) of the other FEA models involved in the multi-level modeling.

2. The method of claim 1 comprising employing FEA methods to perform a multi-level FEA analysis.

3. The method of claim 1 comprising employing homogenization FEA methods to perform a multi-level FEA analysis.

4. The method of claim 1 comprising employing asymptotic homogenization FEA methods to perform a multi-level FEA analysis.

5. The method of claim 1 comprising mapping physiological data to the high-level model based on the diagnostic imaging modality.

6. The method of claim 1 comprising mapping physiological data to micro-level model(s) based on theoretical or alternative imaging modalities at a length scale smaller than the resolution of the imaging modality of claim 1.
